(19) United States
(12) Patent Application Publication
(10) Pub. No.: US 2005/0132805 A1
(43) Pub. Date: Jun. 23, 2005

(54) Capacitance accelerometer having compensation electrode

(76) Inventors: Ho Joon Park, Seoul (KR); Kyoung Soo Chae, Seoul (KR); Won Chul Sim, Sungnam (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/823,706

(22) Filed: Apr. 14, 2004

(30) Foreign Application Priority Data
Dec. 20, 2003 (KR) 2003-94323

(51) Int. Cl. G01P 15/125

(52) U.S. Cl. 73/514.32

(57) ABSTRACT

Disclosed is an accelerometer capable of compensating initial capacitance. In the accelerometer, support beams are extended from a beam-fixing section to elastically support both ends of a horizontally movable floating mass. Movable electrodes are extended outward from both sides of the mass to a predetermined length. Fixed electrodes are extended from electrode-fixing sections to a predetermined length, and alternate with the movable electrodes with a predetermined gap. Compensation electrode sections displace the mass in a moving direction of the mass to equalize an initial capacitance between the movable and fixed electrodes at one side with that between the movable and fixed electrodes at the other side. The invention can simply displace the mass compensation electrodes to equalize initial capacitances at the both ends.

### BACKGROUND OF THE INVENTION

1. Field of the Invention

The present invention relates to an accelerometer, more particularly, which has compensation electrodes arranged at both ends of a mass to displace a mass thereby equalizing initial capacitances at the both ends of the mass.

2. Description of the Related Art

An accelerometer is known as a Micro Electro Mechanical System (MEMS) device. MEMS devices indicate microscale mechanical devices that are electrically controlled and measured, in which the MEMS is a technique for fabricating mechanical and electrical devices through the semiconductor process.

Various accelerometers capable of measuring acceleration are being currently developed, and adopted in vehicle air bag systems, Anti-lock Brake Systems (ABS) and general vibrometers. The accelerometers are mainly fabricated through the semiconductor process, and classified into piezoelectric, piezoresistant and capacitance accelerometers. Piezoelectric accelerometers are commercially retrogressing since it is difficult to prepare piezoelectric thin films of excellent properties without static characteristics. Further, piezoresistant accelerometers show a wide range of characteristic change according to temperature variation, which is hardly compensated. Therefore, the current technical trend is inclined to capacitance accelerometers.

The capacitance accelerometers have very excellent characteristics: A capacitance accelerometer shows a small level of characteristic change according to temperature variation, allows a field effect transistor of a high integrity to constitute a signal processing circuit without additional processes, and can be prepared at low cost.

FIG. 1 is a structural view illustrating a typical accelerometer. As shown in FIG. 1, a conventional capacitance accelerometer 1 includes a floating mass 10 as a movable structure, suspension beams 22 and 24 functioning as springs of a mechanical stiffness for elastically supporting both ends of the mass 10, a plurality of movable electrode fingers 12 and 14 extended outward from the mass 10 into a bilaterally symmetrical configuration seen in the drawing, a plurality of fixed electrode fingers 32 and 34 fixed to both electrode-fixing sections 30a and 30b and spaced from the movable electrode fingers 12 and 14 to a predetermined gap and beam-fixing sections 20a and 20b for fixing the suspension beams 22 and 24 to the bottom of an insulation board. The movable electrode fingers 12 and 14 are adapted to maintain a fixed gap from the fixed electrode fingers 32 and 34 unless any acceleration is applied from the outside so as to keep a predetermined value of capacitance.

The reference numeral 19 designates an etching hole for introducing etching solution therethrough.

Upon application of an external force to the accelerometer 1, the mass 10 is displaced in the direction of the force or the y-axial direction (i.e., the vertical direction seen in the drawing), pulling the movable electrode fingers 12 and 14 fixed thereto in the y-axial direction. This as a result increases and decreases the gaps g1 and g2 from the movable electrode fingers 12 and 14 to the fixed electrode fingers 32 and 34, indicating the displacement of the mass 10.

This changes the capacitance between the movable electrode fingers 12 and 14 and the fixed electrode fingers 32 and 34. The change of capacitance is induced in the form of current into the movable electrode fingers 12 and 14 according to a sensing voltage applied to the fixed electrode fingers 32 and 34, and the current is converted into a voltage and then amplified with an amplifier (not shown) connected to the movable electrode fingers 12 and 14 so that the external acceleration can be measured.

In the accelerometer 1, the movable electrode fingers 12 and 14 alternate with the fixed electrode fingers 32 and 34 in the form of combs to further increase the change of capacitance with respect to the acceleration. With respect to the acceleration in a direction (e.g., the upward direction in the drawing), the movable electrode fingers 12 become nearer to the fixed electrode fingers 32 in the left of the drawing to increase the capacitance C₁ with relation to the initial capacitance Col as expressed in Equation 1 and the movable electrode fingers 14 in the right of the drawing move away from the fixed electrode fingers 34 to decrease the capacitance C₂ with relation to the initial capacitance C₀₂ as expressed in Equation 2:
C₁=C₀₁+AC₀ Equation 1, and
C₂=C₀₂−AC₀ Equation 2.

Therefore, in order to obtain a differential value ACT twice of the change of capacitance, a differential circuit is provided according to Equation 3 below:
ACT=C₁−C₂=2AC₀ Equation 3.

The change of capacitance of the accelerometer is doubled with the differential circuit to obtain a larger positive output signal. Based upon this, the capacitance can be converted with a C-V converter into voltage, and amplified if necessary to obtain an amplification signal.

Also, as shown in FIG. 2, initial capacitances C₀₁ and C₀₂ between the movable electrodes 12 and 14 and the fixed electrodes 32 and 34 can be expressed as in Equation 4 below:
C₀₁ or C₀₂={(ε×h×L/d1)−(ε×h×L/d2)}×N Equation 4,
wherein ε is permittivity, h is the height of the electrode fingers, L is the length of an intersecting portion of the electrode fingers, d1 and d2 are the distances between adjacent electrode fingers, and N is the number of the electrode fingers.

As can be seen from Equation 4, the initial capacitances C₀₁ and C₀₂ are proportional to the height h, the length L and the electrode number N, and inverse proportional to the finger-to-finger distances d1 and d2.

If errors are made in the distances d1 and d2 between the movable electrode finger 12 and the fixed electrode finger 32 and between the movable electrode finger 14 and the fixed electrode finger 34 during the fabrication of the accelerometer 1, the left and right initial capacitances C₀₁ and C₀₂ become different from each other.

If the initial capacitances C₀₁ and C₀₂ become different from each other, an offset of a reference voltage V_{ST} and an output voltage V_{OUT} is generated where the mass 10 having the movable electrodes 12 and 14 is stopped because the output voltage of the accelerometer circuit is obtained according to Equation 5 below:
V_{OUT}=V_{ST}+{V_{ST}×(C₀₁−C₀₂)/C_{F}}×G Equation 5,
wherein V_{OUT} is an output voltage, V_{ST} is a reference voltage, C₀₁ and C₀₂ are left and right initial capacitances, C_{F} is the capacitance of a feedback capacitor which is provided in an amplifier to influence amplification rate as well as to function as a filter, and G indicates the gain of the amplifier connected to a circuit output terminal.

If the initial capacitance C₀₁ between the movable electrode fingers 12 and the fixed electrode fingers 32 in the left becomes different from the initial capacitance C₀₂ between the movable electrode fingers 14 and the fixed electrode fingers 34 in the right owing to process errors in the fabrication of the accelerometer 1, it is necessary to perform compensation in order to equalize the capacitances so that the difference between the initial capacitances C₀₁−C₀₂ becomes zero.

However, a conventional compensation approach for equalizing the initial capacitances C₀₁ and C₀₂ arrays very small capacitances of capacitors in a circuit of the accelerometer, and the capacitors are trimmed through switching on/off to perform compensation. Therefore, this approach complicates an array structure of additionally arranged elements such as the capacitors in the circuit as well as an adjustment operation for equalizing the initial capacitances C₀₁ and C₀₂.

### SUMMARY OF THE INVENTION

Therefore the present invention has been made to solve the foregoing problems of the prior art.

It is an object of the present invention to provide a capacitance accelerometer capable of simply compensating initial capacitances measured between movable and fixed electrodes arranged at both ends of a mass into an equal value in order to obtain a correct output voltage.

According to an aspect of the invention for realizing the object, there is provided an accelerometer capable of compensating initial capacitances comprising: a horizontally movable floating mass; support beams extended from a beam-fixing section to elastically support both ends of the mass; movable electrodes extended outward from both sides of the mass to a predetermined length; fixed electrodes extended from electrode-fixing sections to a predetermined length, and alternating with the movable electrodes with a predetermined gap; and compensation electrode sections for displacing the mass in a moving direction of the mass to equalize an initial capacitance between the movable and fixed electrodes at one side with that between the movable and fixed electrodes at the other side.

It is preferred that the support beams are elastic bodies for connecting the mass with the beam-fixing section which is arranged in an opening formed in a central portion of a body of the mass.

It is preferred that the support beams are elastic bodies for connecting the mass with the beam-fixing sections arranged adjacent to the both ends of the mass.

It is also preferred that the compensation electrode sections include: at least one movable compensation electrode extended outward from the both ends of the mass to a predetermined length; at least one fixed compensation electrode arranged parallel with the movable compensation electrode at a predetermined gap to generate electrostatic force for attracting the movable compensation electrode at application of electric power; and compensation electrode-fixing sections fixed adjacent to the both ends of the mass to power the fixed compensation electrode extended toward the mass to a predetermined length.

It is more preferred that the movable and fixed compensation electrodes are comb-shaped electrode members which are extended to a predetermined length in the moving direction of the mass.

It is more preferred that the movable and fixed compensation electrodes are comb-shaped compensation electrode members which alternate with each other with a uniform gap.

It is also preferred that the compensation electrode sections include a control unit for controlling the movement of the mass, wherein the control unit includes a comparison section for comparing the initial capacitance between the movable and fixed electrodes at one side with that between the movable and fixed electrodes at the other side and a voltage-applying section for selectively applying voltage to a pair of compensation electrode-fixing sections until the comparison value becomes zero.

It is preferred that the compensation electrode sections are separately provided adjacent to the both ends of the mass.

It is more preferred that one of the movable and fixed compensation electrodes has at least one projection which contacts a body of an opposed electrode in the deformation of thereof.

It is more preferred that the projection is extended in the form of a prism to perform point contact with the corresponding movable or fixed compensation electrode.

Also, it is more preferred that the projection is extended in the form of a semicylinder to perform line contact with the corresponding movable or fixed compensation electrode.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a structural view illustrating a typical accelerometer;

FIG. 2 is an enlarged perspective view illustrating the gap variation between movable electrode fingers and fixed electrode fingers in a general accelerometer;

FIG. 3 is a structural view illustrating a capacitance accelerometer having compensation electrodes according to a first embodiment of the invention;

FIG. 4 is a perspective view of the accelerometer taken along a line A-A′ in FIG. 3;

FIG. 5 is a structural view illustrating a capacitance accelerometer having compensation electrodes according to a second embodiment of the invention; and

FIGS. 6A and 6B are perspective views illustrating projections in the capacitance accelerometer having compensation electrodes according to the invention.

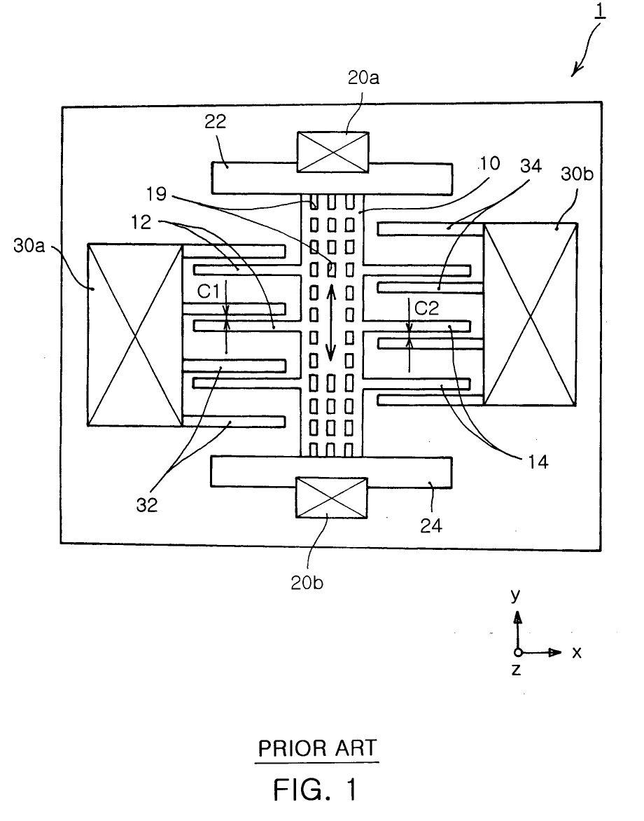

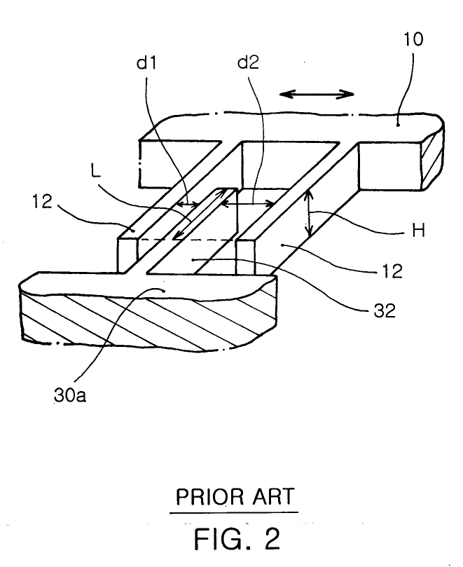

### DETAILED DESCRIPTION OF THE PREFERRED EMBODIMENT

Hereinafter the present invention will now be described in detail with reference to the accompanying drawings.

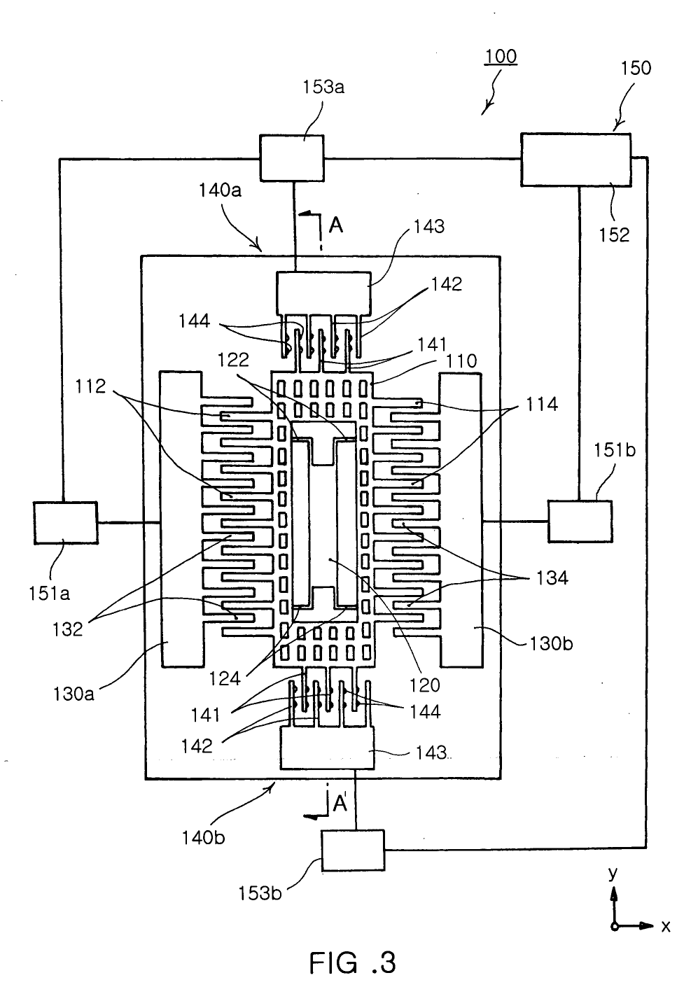

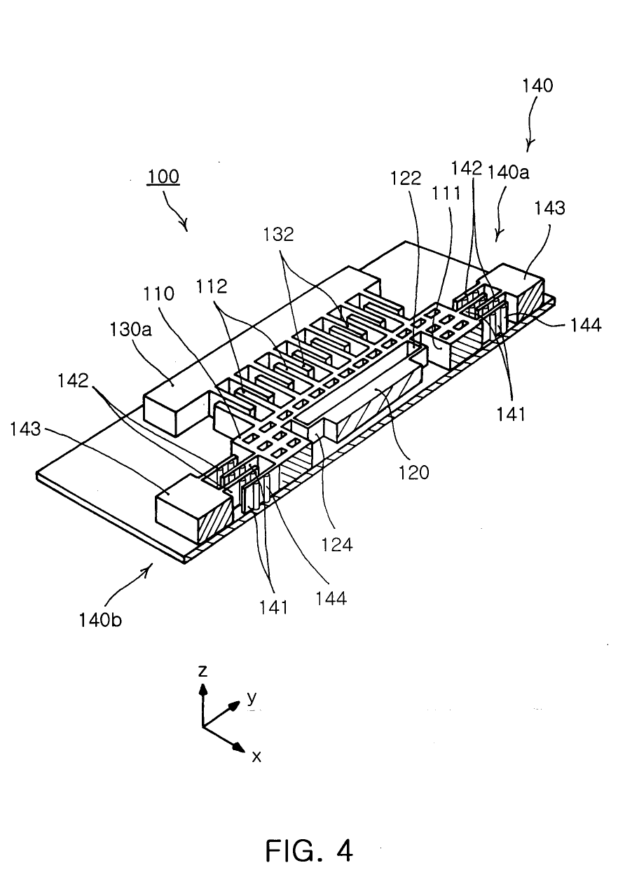

FIG. 3 is a structural view illustrating a capacitance accelerometer having compensation electrodes according to a first embodiment of the invention, and FIG. 4 is a perspective view of the accelerometer taken along a line A-A′ in FIG. 3.

As shown in FIGS. 3 and 4, an accelerometer 100 of the invention is designed to compensate initial capacitances at both ends if different owing to design errors into the same value in order to more precisely measure external acceleration in the movement of the mass, and includes a mass 110, movable electrode fingers 112 and 114, support beams 122 and 124, fixed electrode fingers 132 and 134 and compensation electrode sections 140a and 140b.

The mass 110 has a horizontally movable structure which is suspended by an underlying sacrificial layer, and the support beams 122 and 124 are arranged at both ends of the mass 110 to elastically support the mass 110 in a fashion movable in the y-axial direction in the drawing. The support beams 122 and 124 are of elastic bodies such as a leaf spring of a desired mechanical elastic modulus, and extended toward the mass 110 from a beam-fixing section 120 fixed in position to the bottom.

The mass 110 has an opening 111 perforated in a central portion thereof as shown in FIG. 3, and the support beams 122 and 124 may be of elastic bodies for connecting the beam-fixing section 120 in the opening 111 with the mass 110.

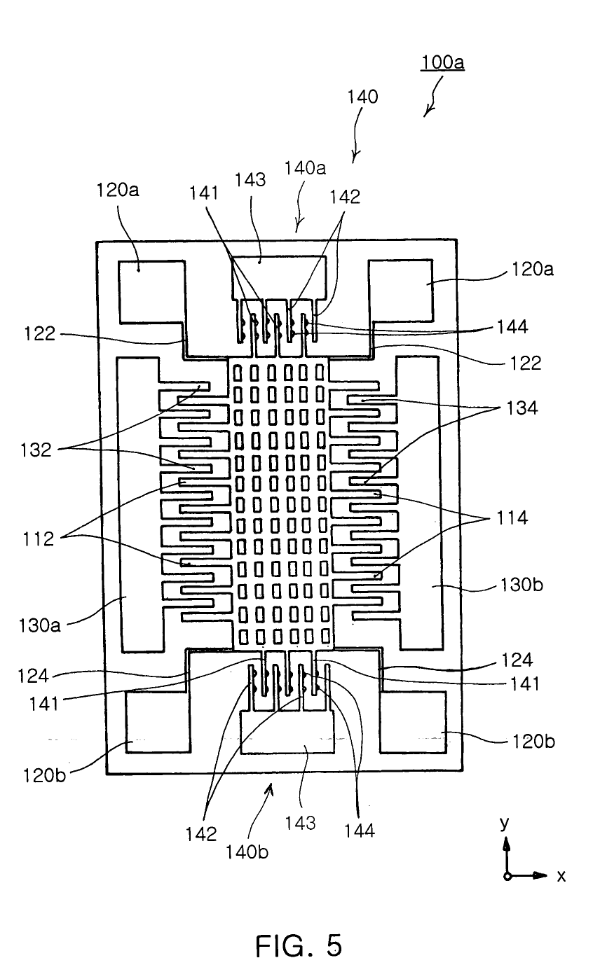

Further, the support beams 122 and 124 may be provided in an alternative accelerometer 10a, as shown in FIG. 5, which includes beam-fixing sections 120a and 120b adjacent to both ends of a mass 110, the support beams 122 and 124 of elastic bodies extended from the beam-fixing sections 120a and 120b to the mass 110 to connect between the same, and compensation electrode sections 140a and 140b arranged at the both ends of the mass 110.

The movable electrode fingers 112 and 114 moving along with the mass 110 are of a plurality of comb-shaped electrode members which are extended outward from both sides of the mass 110 to a predetermined length in a direction perpendicular with respect to the displacement of the mass 110 (e.g., the y-axial direction in the drawing).

The fixed electrode fingers 132 and 134 alternating with the movable electrode fingers 112 and 114 are of a plurality of comb-shaped electrode members which are extended from electrode-fixing sections 130a and 130b fixed at both sides of the mass 110 toward the mass 110 to a predetermined length, and have a predetermined gap from the movable electrode fingers 112 and 114.

The movable electrode fingers 112 and 114 and the fixed electrode fingers 132 and 134 alternate with each other along the moving direction of the mass 110, and are so structured that the upward movement of the mass 110 under the external force narrows the gap d1 between one of the movable electrode fingers 112 and 114 and an adjacent one of the fixed electrode fingers 132 and 134 to increase the capacitance while widening the gap d2 between the fixed electrode finger 132 or 134 and another one of the movable electrode fingers 112 and 114 to decrease the capacitance. The change of capacitance between the movable and fixed electrode fingers 112 and 132 placed in the left of the drawing shows an opposite aspect from that between the movable and fixed electrode fingers 114 and 134 in the placed in the right of the drawing.

The compensation electrode sections 140a and 140b are adapted to displace the mass 110 in the y-axial direction so that the initial capacitance C₀₁ between the left side movable and fixed electrode fingers 112 and 132 becomes the same as the capacitance C₀₂ between the right side movable and fixed electrode fingers 114 and 134.

The compensation electrode sections 140a and 140b are separately provided adjacent to upper and lower ends of the mass 110 to potentially displace the mass 110 supported by the support beams 122 and 124 upward or downward in the drawing.

The compensation electrode sections 140a and 140b are provided at the both ends of the mass 110 to generate external force capable of displacing the mass 110 upward or downward when electric power is applied. Each of the compensation electrode sections 140a and 140b includes at least one movable compensation electrode 141 extended outward from the end of the mass 110 to a predetermined length, at least one fixed compensation electrode 142 extended toward the mass 110 to a predetermined length and arranged parallel with the movable compensation electrode 141 at a predetermined gap to generate electrostatic force for attracting the movable compensation electrode 141 when powered, and a compensation electrode-fixing section 143 fixed adjacent to the end of the mass 110 to apply electric power to the fixed compensation electrode 142.

The movable and fixed compensation electrodes 141 and 142 are of comb-shaped electrode members which are extended in the moving direction of the mass 110 to a predetermined length, in an alternating fashion at a uniform gap.

The compensation electrode sections 140a and 140b include a control unit 150 for controlling bias voltage as external electric power applied to the compensation electrode-fixing sections 143 for displacing the mass 110 at compensation of the initial capacitances C₀₁ and C₀₂ measured in the left and right sides.

The control unit 150 includes measuring sections 151a and 151b for measuring the initial capacitance C₀₁ generated between the movable electrode fingers 112 and the fixed electrode fingers 132 in the left from the mass 110 movable in the y-axial direction and the initial capacitance C₀₂ generated between the movable electrode fingers 114 and the fixed electrode fingers 134 in the right from the mass 110, a comparison section 152 for comparing the measured initial capacitances C₀₁ and C₀₂ received from the measuring sections 151a and 151b to obtain a comparison value and voltage-applying sections 153a and 153b for selectively applying voltages to the compensation electrode-fixing sections 143 of the upper and lower compensation electrode sections 140a and 140b to displace the mass 110 in the y-axial direction until the comparison value obtained in the comparison section 150 becomes zero.

The compensation electrode sections 140a and 140b are separately arranged adjacent to the both ends of the mass 110 to receive desired levels of electric power from the voltage-applying sections 153a and 153b to displace the mass 110 forward or backward in the axial direction. If the comparison value between the initial capacitances C₀₁ and C₀₂ becomes zero, uniformly adjusted electric power is supplied through the voltage-applying sections 153a and 153b without additional change of voltage.

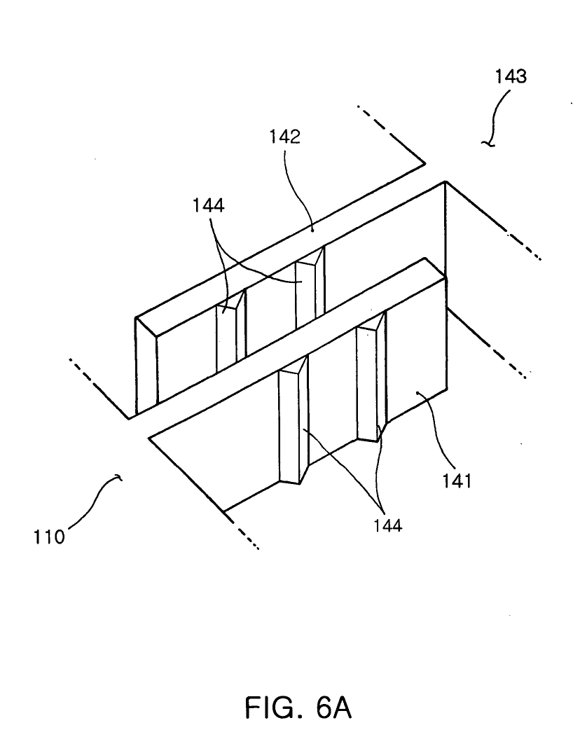

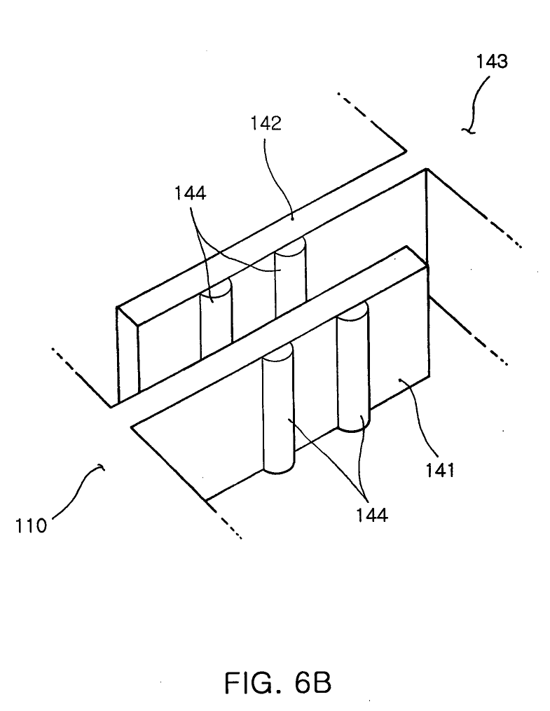

FIGS. 6A and 6B are perspective views illustrating projections in the capacitance accelerometer having compensation electrodes according to the invention.

As shown in FIGS. 6A and 6B, projections 144 are extended outward from the movable compensation electrode 141 or the fixed compensation electrode 142 formed in the movable mass 110 to locally contact opposed fixed or movable compensation electrodes in the deformation of the electrode bodies under the external environment.

It is preferred that the projections 144 are extended in the form of prisms to perform point contact with the corresponding movable or fixed compensation electrode 141 or 152. Alternatively, the projections 144 may be extended in the form of a semicylinder to perform line contact with the corresponding movable or fixed compensation electrode 141 or 142.

When any of the movable and fixed compensation electrodes 141 and 142 is deformed narrowing the gap therebetween, the projections 144 on one of the movable and fixed compensation electrodes 141 and 142 perform point or line contact with the outside surface of an opposed one of the compensation electrodes 141 and 142 to prevent the adhesion between the electrodes 141 and 142 through surface contact so that the displacement of the mass 110 in the y-axial direction is not obstructed.

The movement of the mass 110 is not restricted to the y-axial direction as shown in FIGS. 3 to 5, but the mass 110 may be displaced in x- and y-axial directions according to the position of the accelerometer 1 mounted on a board. The movable and fixed electrodes 112, 114, 132 and 134 associated with the mass 110 may be arranged above and under the mass 110, and the compensation electrode sections 140a and 140b may be arranged respectively adjacent to both ends of the mass 110 to displace the mass 110 in the x- and/or y-axial directions.

If external force is applied to the accelerometer 100, the mass 110 of a movable structure is displaced in the y-axial direction, that is, upward or downward in the drawing perpendicular with respect to the electrode-fixing sections 130a and 130b under the force of inertia.

As a result, the gap between the movable electrode fingers 112 in the left of the mass 110 and the fixed electrode fingers 132 in the left electrode-fixing section 130a is narrowed to increase the capacitance C₁ as in Equation 1 above, but the gap between the movable electrode fingers 114 in the right of the mass 110 and the fixed electrode fingers 134 in the right electrode-fixing section 130b is widened to decrease the capacitance C₂ as in Equation 2 above.

The change of capacitance generated from the accelerometer is processed with a differential circuit as expressed in Equation 3 above into a differential value ACT twice of the change of capacitance, which in turn is converted with a C-V converter into voltage to measure the external acceleration.

In order to obtain the maximum differential value ACT with the differential circuit, the initial capacitances C₀₁ and C₀₂ measured in the left and right sides should be equal. Errors generated during the fabrication of the accelerometer 100 cause the movable electrode fingers 112 and 114 and the fixed electrode fingers 132 and 134 to have uneven thickness and thus irregular gap so that the initial capacitance C₀₁ measured in the left measuring section 151a becomes different from the initial capacitance C₀₂ measured in the right measuring section 151b.

The comparison section 152 compares the measured initial capacitances C₀₁ and C₀₂ received from the measuring sections 151a and 151b to obtain a comparison value. If the comparison value is positive (+) or the left initial capacitance C₀₁ is larger than the right initial capacitance C₀₂, the comparison section 152 widens the gap between the movable electrode fingers 112 and the fixed electrode fingers 132 in the left to decrease the initial capacitance C₀₁ while narrowing the gap between the movable electrode fingers 114 and the fixed electrode fingers 134 in the right to relatively increase the initial capacitance C₀₂ so that the comparison value becomes zero.

When bias voltage is applied through the voltage-applying section 153b that is electrically connected to the compensation electrode-fixing section 143 of the lower one of the compensation electrode sections 140a and 140b provided respectively above and under the mass 110, electrostatic force is generated between the fixed compensation electrode 142 of the compensation electrode-fixing section 143 and the movable compensation electrode 141 of the mass 110 to place the mass 110 downward to equally compensate the left and right initial capacitances.

If the comparison value of the left and right initial capacitances C₀₁ and C₀₂ becomes zero, the comparison section 152 stops application of the bias voltage to the compensation electrode-fixing section 143 via the voltage-applying sections 153a and 153b so that adjusted voltage is uniformly supplied.

According to the present invention as set forth above, the compensation electrode sections capable of displacing the mass in the moving direction thereof at application of voltage are provided respectively at both ends of the mass so that the different initial capacitances measured above and under or in the left and right of the mass resulting from process errors generated during the fabrication of the accelerometer can be simply compensated to an equal value. As a result, unlike the prior art requiring a complicated structure of capacitors for adding capacitances to a circuit in a board to perform compensation or a complicated compensation process, the present invention can simplify the overall structure of the accelerometer as well as perform the compensation more simply.

While the present invention has been shown and described in connection with the preferred embodiments, it will be apparent to those skilled in the art that modifications and variations can be made without departing from the spirit and scope of the invention as defined by the appended claims.

1. An accelerometer capable of compensating initial capacitances comprising:
a horizontally movable floating mass;
support beams extended from a beam-fixing section to elastically support both ends of the mass;
movable electrodes extended outward from both sides of the mass to a predetermined length;
fixed electrodes extended from electrode-fixing sections to a predetermined length, and alternating with the movable electrodes with a predetermined gap; and
compensation electrode sections for displacing the mass in a moving direction of the mass to equalize an initial capacitance between the movable and fixed electrodes at one side with that between the movable and fixed electrodes at the other side.

2. The accelerometer capable of compensating initial capacitances according to claim 1, wherein the support beams are elastic bodies for connecting the mass with the beam-fixing section which is arranged in an opening formed in a central portion of a body of the mass.

3. The accelerometer capable of compensating initial capacitances according to claim 1, wherein the support beams are elastic bodies for connecting the mass with the beam-fixing sections arranged adjacent to the both ends of the mass.

4. The accelerometer capable of compensating initial capacitances according to claim 1, wherein the compensation electrode sections include:
at least one movable compensation electrode extended outward from the both ends of the mass to a predetermined length;
at least one fixed compensation electrode arranged parallel with the movable compensation electrode at a predetermined gap to generate electrostatic force for attracting the movable compensation electrode at application of electric power; and
compensation electrode-fixing sections fixed adjacent to the both ends of the mass to power the fixed compensation electrode extended toward the mass to a predetermined length.

5. The accelerometer capable of compensating initial capacitances according to claim 4, wherein the movable and fixed compensation electrodes are comb-shaped electrode members which are extended to a predetermined length in the moving direction of the mass.

6. The accelerometer capable of compensating initial capacitances according to claim 4, wherein the movable and fixed compensation electrodes are comb-shaped compensation electrode members which alternate with each other with a uniform gap.

7. The accelerometer capable of compensating initial capacitances according to claim 1, wherein the compensation electrode sections include a control unit for controlling the movement of the mass, and
wherein the control unit includes a comparison section for comparing the initial capacitance between the movable and fixed electrodes at one side with that between the movable and fixed electrodes at the other side and a voltage-applying section for selectively applying voltage to a pair of compensation electrode-fixing sections until the comparison value becomes zero.

8. The accelerometer capable of compensating initial capacitances according to claim 1, wherein the compensation electrode sections are separately provided adjacent to the both ends of the mass.

9. The accelerometer capable of compensating initial capacitances according to claim 4, wherein one of the movable and fixed compensation electrodes has at least one projection which contacts a body of an opposed electrode in the deformation of thereof.

10. The accelerometer capable of compensating initial capacitances according to claim 9, wherein the projection is extended in the form of a prism to perform point contact with the corresponding movable or fixed compensation electrode.

11. The accelerometer capable of compensating initial capacitances according to claim 9, wherein the projection is extended in the form of a semicylinder to perform line contact with the corresponding movable or fixed compensation electrode.
